(19) United States
(12) Patent Application Publication
(10) Pub. No.: US 2026/0229718 A1
(43) Pub. Date: Aug. 6, 2026

(54) BATTERY

(71) Applicant: TOYOTA JIDOSHA KABUSHIKI KAISHA, Toyota-shi (JP)

(72) Inventor: Junta TAKASU, Nagoya-shi (JP)

(73) Assignee: TOYOTA JIDOSHA KABUSHIKI KAISHA, Toyota-shi (JP)

(21) Appl. No.: 19/422,962

(22) Filed: Dec. 17, 2025

(30) Foreign Application Priority Data
Feb. 6, 2025 (JP) 2025-018095

(51) Int. Cl. H01M 50/533; H01M 4/04; H01M 10/0525; H01M 50/534

(52) U.S. Cl. CPC H01M 50/533; H01M 4/0404; H01M 10/0525; H01M 50/534

(57) ABSTRACT

A battery includes a plurality of first electrodes disposed at intervals that are predetermined. In the battery, each of the first electrodes includes a first collector foil and a first electrode layer on a first surface of the first collector foil, a position of at least one end part of four end parts of the first electrode layer in a surface direction is the same as a position of at least one end part of four end parts of the first collector foil in the surface direction, at least one side surface of four side surfaces of the first electrode is coplanar, and the first electrodes are disposed on a first surface of a single second collector foil at intervals that are predetermined.

### CROSS-REFERENCE TO RELATED APPLICATION

This application claims priority to Japanese Patent Application No. 2025-018095 filed on February 6, 2025. The disclosure of the above-identified application, including the specification, drawings, and claims, is incorporated by reference herein in its entirety.

### BACKGROUND

### 1. Technical Field

The present disclosure relates to a battery.

### 2. Description of Related Art

Various techniques have been proposed for a battery as disclosed in Japanese Unexamined Patent Application Publication No. 2019-192338 (JP 2019-192338 A), Japanese Unexamined Patent Application Publication No. 2001-357836 (JP 2001-357836 A), and Japanese Unexamined Patent Application Publication No. 2024-176140 (JP 2024-176140 A).

### SUMMARY

In JP 2019-192338 A, a structure in which a slit-shaped groove is provided in an electrode in an all-solid state battery to suppress a decrease in capacity is disclosed. It is difficult to avoid the an occurrence of a droop of an electrode composite material at an edge portion of a portion coated with the electrode composite material in a case where the groove (an uncoated portion where the electrode composite material is not coated) is formed in the electrode, so that this becomes a cause of a decrease in the capacity of the electrode. Therefore, in the electrode having a large number of grooves, an area in which the capacity of the electrode is lost is larger compared to the electrode having a small number of grooves or no grooves.

The present disclosure has been made in view of the circumstances, and a main object thereof is to provide a battery capable of suppressing a decrease in capacity of an electrode.

That is, the present disclosure includes the following aspects.

A battery includes a plurality of first electrodes. In the battery,

each of the first electrodes includes a first collector foil and a first electrode layer on a first surface of the first collector foil,

a position of at least one end part of four end parts of the first electrode layer in a surface direction is the same as a position of at least one end part of four end parts of the first collector foil in the surface direction,

at least one side surface of four side surfaces of the first electrode is coplanar, and

the first electrodes are disposed on a first surface of a single second collector foil at intervals that are predetermined.

In the battery according to 1,

the first collector foil includes a resin and an inorganic filler having conductivity, and

the resin is a thermally fusible resin.

In the battery according to 1,

each of the first collector foils of the first electrodes is bonded to the second collector foil through an adhesive layer,

the adhesive layer includes an adhesive and an inorganic filler having conductivity, and

the adhesive is a thermally fusible resin.

A manufacturing method of the battery according to 1 includes

forming the first electrode layer on the first surface of the first collector foil by dry film formation.

The manufacturing method according to 4 further includes

preparing the first electrodes after the forming, and

disposing the first electrodes on the first surface of the single second collector foil at the intervals that are predetermined.

According to the present disclosure, it is possible to provide a battery capable of suppressing a decrease in capacity of an electrode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an example of a part of a bipolar battery according to the present disclosure;

FIG. 2 is a schematic view showing another example of a part of the bipolar battery according to the present disclosure;

FIG. 3 is a schematic view showing an example of a monopolar battery according to the present disclosure; and

FIG. 4 is a schematic view showing an example of a part of a bipolar battery in the related art.

### DETAILED DESCRIPTION OF EMBODIMENTS

In the present disclosure, there is provided a battery including a plurality of first electrodes, in which

the first electrode includes a first collector foil and a first electrode layer on a first surface of the first collector foil,

a position of at least one end part of four end parts of the first electrode layer in a surface direction is the same as a position of at least one end part of four end parts of the first collector foil in the surface direction,

at least one side surface of four side surfaces of the first electrode is coplanar, and

the first electrodes are disposed on a first surface of a single second collector foil at intervals that are predetermined.

According to the present disclosure, a plurality of first electrodes including the first electrode layer coated in advance on the first collector foil is produced, and the first electrodes are bonded to the single second collector foil in a floating island shape to form an electrode having no electrode composite material droop at an edge portion of the first electrode layer. According to the present disclosure, it is possible to eliminate the electrode composite material droop portion and suppress a decrease in capacity of the electrode.

### First electrode

The battery according to the present disclosure includes the first electrodes.

The first electrode includes a first collector foil and a first electrode layer on a first surface of the first collector foil.

The first electrode is a positive electrode or a negative electrode. In a case where the first electrode is the positive electrode, the first electrode layer is a positive electrode layer. In a case where the first electrode is the negative electrode, the first electrode layer is a negative electrode layer.

In a plan view, the first electrode, the first collector foil, and the first electrode layer may have a quadrangular shape, and particularly may have a rectangular shape. The first electrode, the first collector foil, and the first electrode layer may be a quadrangular prism.

A position of at least one end part of four end parts of the first electrode layer in a surface direction is the same as a position of at least one end part of four end parts of the first collector foil in the surface direction. That is, the first electrode has at least one side of a first electrode layer end and at least one side of a first collector foil end that share the same end part position. Positions of four end parts of the first electrode layer in the surface direction may be the same as positions of four end parts of the first collector foil in the surface direction.

At least one side surface of four side surfaces of the first electrode is coplanar.

The first electrodes are disposed on a first surface of one second collector foil at intervals that are predetermined. The intervals that are predetermined is not particularly limited, and can be appropriately set to reduce the loss of the electrode capacity.

The number of the first electrodes may be, for example, 2 to 100.

The first electrode layer may have a single layer structure or a two-layer structure.

The first electrode layer includes at least an electrode active material, and may include a conductive material, a binder, and the like, which will be described later, as necessary. The electrode active material is a positive electrode active material or a negative electrode active material, which will be described later.

The battery according to the present disclosure may have an electrolyte layer on a surface of the first electrode layer on a side opposite to a surface on the first collector foil side.

The battery according to the present disclosure includes a second collector foil.

The battery according to the present disclosure may include the second collector foil on a second surface of the first collector foil on a side opposite to the first surface.

The first collector foil may be bonded to the second collector foil. The first collector foil may be electrically joined to the second collector foil.

In the present disclosure, in a case where the first electrode is a positive electrode, the first collector foil and the second collector foil are a first positive electrode collector foil and a second positive electrode collector foil, respectively, and in a case where the first electrode is a negative electrode, the first collector foil and the second collector foil are a first negative electrode collector foil and a second negative electrode collector foil, respectively.

At least one end part of a plurality of end parts of the first collector foil in the surface direction toward the outside of the battery may include a protruding portion that extends to the outside of the battery and does not face the first electrode layer.

The first collector foil may include a metal material. Examples of the metal material that can be used for the first collector foil include SUS, Cr, Au, Pt, Zn, Al, copper, nickel, iron, and titanium.

The second collector foil may include a metal material. Examples of the metal material that can be used for the second collector foil include the same materials as the metal material that can be used for the first collector foil.

The thicknesses of the first collector foil and the second collector foil may be, for example, 1 μm to 30 μm.

The first collector foil may include a resin.

The first collector foil may include a resin and an inorganic filler having conductivity.

The resin may be a thermally fusible resin, a modified silicone, an epoxy resin, or the like. The thermally fusible resin may be a modified polyolefin. The modified polyolefin may be maleic acid-modified polypropylene, acid-modified polyethylene, or the like.

The conductive filler may be carbon, Ni, Co, or the like.

From the viewpoint of suppressing corrosion due to an electrolytic solution, the first collector foil may have a three-layer structure including an Al layer, a resin layer including polyethylene terephthalate and an inorganic filler, and an Al layer in this order.

The first collector foil may be bonded to the second collector foil through an adhesive layer. In a case where the first collector foil includes a resin, the first collector foil has a function of the adhesive layer, and thus the adhesive layer is not necessarily required. In a case where the first collector foil includes a metal material, the adhesive layer may be provided from the viewpoint of immobilization with the second collector foil.

The adhesive layer may be a layer that is fused and can be bonded to a different material such as a metal. The adhesive layer may include an adhesive and an inorganic filler having conductivity.

The adhesive may be a resin. Examples of the resin include the same resins as the resin that can be used for the first collector foil. Examples of the inorganic filler include the same inorganic fillers as the inorganic filler that can be used for the first collector foil.

The thickness of the adhesive layer may be, for example, 0.1 μm to 4 μm.

The battery according to the present disclosure includes the second collector foil and the first electrodes, and usually further includes an electrolyte layer and a second electrode.

The electrolyte layer may be disposed on a surface of the first electrodes on a side opposite to a surface in contact with the second collector foil.

### Second electrode

The second electrode may be disposed on a second surface of the second collector foil on a side opposite to the first surface on which the first electrodes are disposed, or may be disposed on a surface of the electrolyte layer on a side opposite to a surface in contact with the first electrodes.

The second electrode is a negative electrode in a case where the first electrode is a positive electrode, and is a positive electrode in a case where the first electrode is a negative electrode.

The second electrode may include a second electrode layer and a third collector foil.

In a case where the second electrode is a positive electrode, the second electrode layer and the third collector foil are a positive electrode layer and a positive electrode collector foil, respectively, and in a case where the second electrode is a negative electrode, the second electrode layer and the third collector foil are a negative electrode layer and a negative electrode collector foil, respectively.

### Positive electrode

The positive electrode includes the positive electrode layer and the positive electrode collector foil.

The positive electrode layer may be disposed on one surface of the positive electrode collector foil, or may be disposed on both surfaces of the positive electrode collector foil. The positive electrode may have a multilayer structure in which two or more positive electrode layers are provided on at least one surface of the positive electrode collector foil. In addition, in a case where two or more positive electrode layers are provided, the types of the positive electrode active materials included in each positive electrode layer may be the same or different from each other.

The positive electrode layer is a layer containing at least a positive electrode active material. In addition, the positive electrode layer may contain at least one of a solid electrolyte, a conductive material, or a binder as necessary.

Examples of the positive electrode active material include an oxide active material. Examples of the oxide active material include a rock salt layer-type active material such as LiCoO₂, LiMnO₂, LiNiO₂, LiVO₂, LiNi_{1/3}Co_{1/3}Mn_{1/3}O₂, and LiNi_{0.8}Mn_{0.1}Co_{0.1}O₂. In addition, examples of the oxide active material include a spinel-type active material such as LiMn₂O₄, Li₄Ti₅O₁₂, and Li(Ni_{0.5}Mn_{1.5})O₄. Furthermore, examples of the oxide active material include an olivine-type active material such as LiFePO₄, LiMnPO₄, LiNiPO₄, and LiCoPO₄.

A coating layer containing a Li ion-conductive compound may be provided on a surface of the positive electrode active material. It is because a reaction between the positive electrode active material and a solid electrolyte (particularly, a sulfide solid electrolyte) can be suppressed. Examples of the Li ion-conductive compound include B₂O₃, Li₂B₄O₇, LiBPO₄, Li₃PO₄, LiPO₃, and LiNbO₃. The thickness of the coating layer is, for example, 1 nm or

more and 30 nm or less. A coating rate of the Li ion-conductive compound that coats the positive electrode active material is, for example, 70% or more, and may be 90% or more or 100%. A method of coating the Li ion-conductive compound is not particularly limited, and a method known in the related art can be appropriately adopted.

A shape of the positive electrode active material is usually in a particulate form. The positive electrode active material may be a primary particle or a secondary particle in which primary particles are aggregated.

An average particle diameter of the positive electrode active material is not particularly limited, but is, for example, 0.01 μm or more and 50 μm or less, and may be 0.5 μm or more and 30 μm or less.

In the present disclosure, an example of a method of calculating the average particle diameter of the particles is as follows. First, in a transmission electron microscope (hereinafter, referred to as TEM) image or a scanning electron microscope (hereinafter, referred to as SEM) image at an appropriate magnification (for example, 50,000 to 1,000,000 times), a particle diameter of one particle is calculated in a case where the particle is regarded as a spherical shape. The particle diameter is calculated by such TEM observation or SEM observation for 2 to 300 particles of the same type, and an average of the particles is defined as an average particle diameter.

A proportion of the positive electrode active material in the positive electrode layer is, for example, 20% by mass or more, and may be 30% by mass or more or 40% by mass or more. In a case where the proportion of the positive electrode active material is too small, there is a possibility that sufficient energy density cannot be obtained. On the other hand, the proportion of the positive electrode active material in the positive electrode layer is, for example, 95% by mass or less, and may be 70% by mass or less or 60% by mass or less. In a case where the proportion of the positive electrode active material is too large, there is a possibility that the ion conductivity and the electron conductivity in the positive electrode layer may be relatively reduced.

The positive electrode layer may contain a solid electrolyte. By adding the solid electrolyte, the ion conductivity of the positive electrode layer is improved. The solid electrolyte may be an inorganic solid electrolyte such as a sulfide solid electrolyte, a halide solid electrolyte, an oxide solid electrolyte, or a complex hydride solid electrolyte, or may be an organic solid electrolyte such as a gel electrolyte.

From the viewpoint of handleability, the shape of the solid electrolyte may be a particulate form.

In addition, an average particle diameter of the solid electrolyte is not particularly limited, and may be 1 nm to 100 μm.

A proportion of the solid electrolyte in the positive electrode layer may be, for example, 1% by mass or more. In a case where the proportion of the solid electrolyte is too small, there is a possibility that an ion conduction path in the positive electrode layer is insufficient. On the other hand, the proportion of the solid electrolyte in the positive electrode layer may be, for example, 60% by mass or less. In a case where the proportion of the solid electrolyte is too large, the proportion of the positive electrode active material is relatively reduced, and there is a possibility that the energy density may be reduced.

The positive electrode layer may contain a conductive material. By adding the conductive material, the electron conductivity of the positive electrode layer is improved. Examples of the conductive material include a carbon-based conductive material, metal particles, and a conductive polymer. Examples of the carbon-based conductive material include particulate materials such as acetylene black (AB) and Ketjen black (KB). In addition, examples of the carbon-based conductive material include fibrous materials such as vapor-grown carbon fiber (VGCF), carbon nanotube (CNT), and carbon nanofiber (CNF).

A proportion of the conductive material in the positive electrode layer may be, for example, 0.1% by mass or more. In a case where the proportion of the conductive material is too small, there is a possibility that an electron conduction path in the positive electrode layer is insufficient. On the other hand, the proportion of the conductive material in the positive electrode layer may be, for example, 5% by mass or less. In a case where the proportion of the conductive material is too large, the proportion of the positive electrode active material is relatively reduced, and there is a possibility that the energy density may be reduced.

The positive electrode layer may contain a binder. Examples of the binder include styrene-butadiene rubber (SBR), polyimide (PI), polyacrylic acid (PAA), acrylonitrile-butadiene rubber (NBR), butadiene rubber (BR), polyvinylidene fluoride (PVdF), polytetrafluoroethylene (PTFE), styrene-isoprene-styrene block copolymer (SIS), and ethylene-propylene-diene copolymer (EPDM).

A proportion of the binder in the positive electrode layer may be, for example, 0.5% by mass or more. In a case where the proportion of the binder is too small, there is a possibility that an increase in resistance due to charging and discharging cannot be sufficiently reduced. On the other hand, the proportion of the binder in the positive electrode layer may be, for example, 15% by mass or less. In a case where the proportion of the binder is too large, the proportion of the positive electrode active material is relatively reduced, and there is a possibility that the energy density may be reduced.

A thickness of the positive electrode layer is, for example, 0.1 μm or more and 1,000 μm or less, and may be 1 μm or more and 500 μm or less, or 30 μm or more and 100 μm or less.

A manufacturing method of the positive electrode layer is not particularly limited, and examples thereof include a method of obtaining a positive electrode slurry by mixing the positive electrode active material, the solid electrolyte, and a solvent, coating the positive electrode slurry on a positive electrode collector foil, and drying the positive electrode slurry to form a positive electrode layer. In a case of forming the positive electrode layer, a pressing treatment of pressing the positive electrode layer in a thickness direction may be performed. Examples of the pressing treatment include a roller press and a flat plate press.

Examples of the solvent include N-methylpyrrolidone (NMP), tetralin, diisobutyl ketone, butyl butyrate, mesitylene, heptane, dibutyl ether, decane, dodecane, isodecane, and toluene. The solvent may include two or more components thereof.

### Negative electrode

The negative electrode includes the negative electrode layer and the negative electrode collector foil.

The negative electrode layer may be disposed on one surface of the negative electrode collector foil, or may be disposed on both surfaces of the negative electrode collector foil. The negative electrode may have a multilayer structure in which two or more negative electrode layers are provided on at least one surface of the negative electrode collector foil. In addition, in a case where two or more negative electrode layers are provided, the types of the negative electrode active materials included in each negative electrode layer may be the same or different from each other.

The negative electrode layer is a layer containing at least a negative electrode active material. In addition, the negative electrode layer may contain at least one of a solid electrolyte, a conductive material, or a binder as necessary.

The negative electrode active material may include at least one selected from the group consisting of a carbon-based active material, an Li-based active material, an Si-based active material, an Si-C composite material, and lithium titanate. The carbon-based active material may include at least one selected from the group consisting of graphite, soft carbon, and hard carbon. Examples of the Li-based active material include Li, Li silicate, and an Li alloy. Examples of the Si-based active material include Si, SiO, and an Si alloy. The Si-C composite material indicates a composite material of a carbon-based active material (graphite or the like) and an Si-based active material (Si or the like).

The negative electrode layer may contain 10% by mass or more of the negative electrode active material, may contain 20% by mass or more of the negative electrode active material, may contain 50% by mass or more of the negative electrode active material, may contain 100% by mass or less of the negative electrode active material, or may contain 90% by mass or less of the negative electrode active material.

Examples of the solid electrolyte, the conductive material, and the binder used for the negative electrode layer include the same materials as those described for the positive electrode layer.

A proportion of the solid electrolyte in the negative electrode layer may be, for example, 0% by mass or more and 60% by mass or less.

A proportion of the conductive material in the negative electrode layer may be, for example, 0.1% by mass or more and 5% by mass or less.

A proportion of the binder in the negative electrode layer may be, for example, 0.5% by mass or more and 15% by mass or less.

### Electrolyte layer

An electrolyte layer is a layer provided between the positive electrode layer and the negative electrode layer, and contains at least an electrolyte. The electrolyte may be a solid electrolyte or may be a liquid electrolyte (electrolytic solution).

The electrolyte layer may include a solid electrolyte, an electrolytic solution, and the like.

Examples of the solid electrolyte include the same materials as those described for the positive electrode layer.

As the electrolytic solution, an aqueous electrolytic solution, a non-aqueous electrolytic solution, or the like can be used. The electrolytic solutions may be used alone or in combination of two or more kinds thereof.

The solvent of the aqueous electrolytic solution contains water as a main component. That is, water may occupy 50 mol% or more, particularly 70 mol% or more, and further 90 mol% or more with respect to the total amount of the solvent (liquid component) constituting the electrolytic solution (100 mol%). On the other hand, an upper limit of the proportion of water in the solvent is not particularly limited.

The solvent contains water as a main component, but may contain a solvent other than water. Examples of the solvent other than water include one or more selected from ethers, carbonates, nitriles, alcohols, ketones, amines, amides, sulfur compounds, and hydrocarbons. The solvent other than water may be 50 mol% or less, particularly 30 mol% or less, and further 10 mol% or less with respect to the total amount of the solvent (liquid component) constituting the electrolytic solution (100 mol%).

The aqueous electrolytic solution used in the present disclosure contains an electrolyte. As the electrolyte for the aqueous electrolytic solution, a known electrolyte in the related art can be used. Examples of the electrolyte include a lithium salt of an imide acid compound, a nitrate, an acetate, and a sulfate. Specific examples of the electrolyte include lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(nonafluorobutanesulfonyl)imide, lithium nonafluoro-N-[(trifluoromethane)sulfonyl]butanesulfonylamide, lithium N,N-hexafluoro-1,3-disulfonylimide, CH₃COOLi, LiPF₆, LiBF₄, Li₂SO₄, and LiNO₃.

A concentration of the electrolyte in the aqueous electrolytic solution can be appropriately set according to the characteristics of the battery to be obtained within a range not exceeding the saturation concentration of the electrolyte with respect to the solvent. The reason is that, in a case where a solid electrolyte remains in the aqueous electrolytic solution, the solid may hinder the battery reaction.

For example, in a case where LiTFSI is used as the electrolyte, the aqueous electrolytic solution may contain 1 mol or more, particularly 5 mol or more, and further 7.5 mol or more

of LiTFSI per 1 kg of water. The upper limit thereof is not particularly limited, and may be, for example, 25 mol or less.

As the non-aqueous electrolytic solution, a solution containing a lithium salt and a non-aqueous solvent is usually used.

Examples of the lithium salt include inorganic lithium salts such as LiPF₆, LiBF₄, LiClO₄, and LiAsF₆; and organic lithium salts such as LiCF₃SO₃, LiN(SO₂CF₃)₂ (Li-TFSI), LiN(SO₂C₂F₅)₂, and LiC(SO₂CF₃)₃.

Examples of the non-aqueous solvent include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethyl sulfoxide (DMSO), and mixtures thereof. From the viewpoint of ensuring a high dielectric constant and a low viscosity, the non-aqueous solvent may be a mixture of a cyclic carbonate compound having a high dielectric constant and a high viscosity, such as EC, PC, and BC and a chain-like carbonate compound having a low dielectric constant and a low viscosity, such as DMC, DEC, and EMC. The non-aqueous solvent may be a mixture of EC and DEC.

A concentration of the lithium salt in the non-aqueous electrolytic solution may be, for example, 0.3 M to 5 M.

As the electrolyte layer, a separator which is impregnated with the electrolytic solution and prevents the contact between the positive electrode layer and the negative electrode layer may be used.

The material of the separator is not particularly limited as long as it is a porous film, and examples thereof include resins such as polyethylene (PE), polypropylene (PP), polyester, polyvinyl alcohol, cellulose, and polyamide. The material of the separator may be polyethylene or polypropylene among these. In addition, the separator may have a single layer structure or a multi-layer structure. Examples of the separator having a multi-layer structure include a separator having a two-layer structure of PE/PP, and a separator having a three-layer structure of PP/PE/PP or PE/PP/PE.

The separator may be a nonwoven fabric such as a resin nonwoven fabric or a glass fiber nonwoven fabric.

### Solid electrolyte layer

The electrolyte layer may be a solid electrolyte layer composed of a solid.

In a case where the electrolyte layer is the solid electrolyte layer, the solid electrolyte layer contains a solid electrolyte, and may contain a binder or the like as necessary.

Examples of the solid electrolyte include the same materials as those described for the positive electrode layer.

One kind of the solid electrolyte may be used alone, or two or more kinds thereof may be used. In addition, in a case where two or more kinds of the solid electrolytes are used, the two or more kinds of the solid electrolytes may be mixed, or a multilayer structure may be formed by forming a layer of each of two or more kinds of the solid electrolytes.

A proportion of the solid electrolyte in the solid electrolyte layer is not particularly limited, but is, for example, 50% by mass or more, and may be in a range of 60% by mass or more and 100% by mass or less, may be in a range of 70% by mass or more and 100% by mass or less, or may be 100% by mass. The solid electrolyte layer may contain an electrolytic solution of less than 1% by mass with respect to the total amount of the solid electrolyte layer.

Examples of the binder include a binder that can be contained in the positive electrode layer described above.

A content of the binder in the solid electrolyte layer may be 0% by mass to 10% by mass with respect to the total amount of the solid electrolyte layer.

A thickness of the electrolyte layer is, for example, 0.1 μm or more and 1,000 μm or less, and may be 0.1 μm or more and 500 μm or less, or 0.1 μm or more and 100 μm or less.

The battery according to the present disclosure may further have a constraint tool that applies a constraint pressure to the positive electrode layer, the electrolyte layer, and the negative electrode layer in the thickness direction. In particular, when the electrolyte layer is a solid electrolyte layer, a constraint pressure may be applied in order to form a favorable ion conduction path and electron conduction path. The constraint pressure is, for example, 0.1 MPa or more, and may be 1 MPa or more or may be 5 MPa or more. Meanwhile, the constraint pressure is, for example, 100 MPa or less, and may be 50 MPa or less or may be 20 MPa or less.

### Battery

A type of the battery according to the present disclosure is not particularly limited, but is typically a lithium ion battery. In addition, the battery according to the present disclosure may be a liquid battery in which the electrolyte layer contains an electrolytic solution, or may be a solid state battery in which the electrolyte layer contains a solid electrolyte. The solid state battery may be a semi-solid state battery or may be an all-solid state battery. In the present disclosure, the semi-solid state battery is a battery in which the electrolyte layer has a solid component (for example, an inorganic solid electrolyte) and a liquid component (for example, a solvent and an electrolytic solution). In the present disclosure, the all-solid state battery is a battery in which the electrolyte layer has only a solid component such as an inorganic solid electrolyte. In addition, the battery according to the present disclosure may be a primary battery or a secondary battery, and may be a secondary battery among these. It is because a secondary battery can be repeatedly charged and discharged and is useful, for example, as an in-vehicle battery.

In a case of a battery stack in which a plurality of batteries are laminated, the battery stack may be a monopolar type or a bipolar type.

Examples of the application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, the battery may be used as a power source for driving a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

### Manufacturing method of battery

In the present disclosure, there is provided a manufacturing method of the battery including

forming the first electrode layer on the first surface of the first collector foil by dry film formation.

The manufacturing method of the battery includes a step (forming step) of forming the first electrode layer on the first surface of the first collector foil by dry film

formation. The manufacturing method of the battery may further include a step (preparation step) of preparing the first electrodes after the forming step, and a step (disposition step) of disposing the first electrodes on the first surface of the single second collector foil at intervals that are predetermined.

In the forming step, the first electrode layer is formed by dry film formation, so that a solvent is not required, and manufacturing costs can be reduced. In the forming step, a laminate in which the first electrode layer is formed on the first surface of the first collector foil is obtained.

In the preparation step, a plurality of the laminates are obtained by repeating the forming step. The end part of each of the laminates may be cut such that at least one side of the first electrode layer end and at least one side of the first collector foil end share the same end part position, that is, such that at least one side surface of four side surfaces of each of the laminates is coplanar, to obtain the first electrodes.

In the disposition step, the first electrodes prepared in the preparation step are disposed on the first surface of the single second collector foil. The intervals that are predetermined in a case of disposing the first electrodes on the first surface of the single second collector foil is as described above.

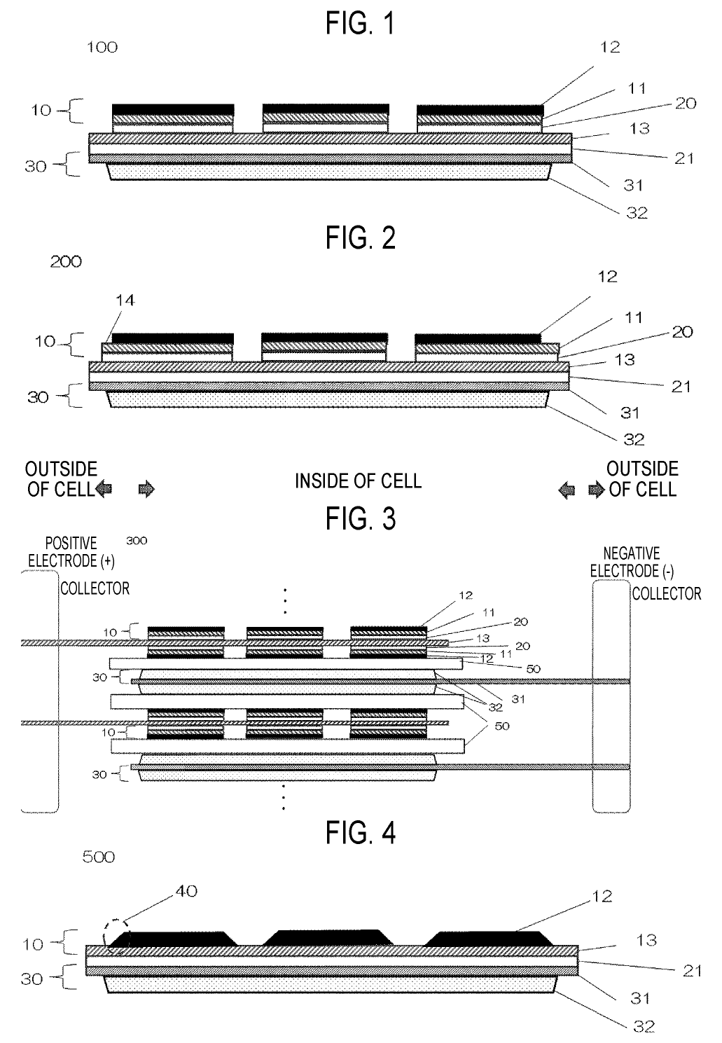

FIG. 1 is a schematic view showing an example of a part of a bipolar battery according to the present disclosure.

As shown in FIG. 1, a bipolar battery 100 according to the present disclosure includes a plurality of first electrodes 10 each of which includes a first electrode layer 12 on a first surface of a first collector foil 11. As shown in FIG. 1, at least two sides of the first electrode layer end and at least two sides of the first collector foil end share the same end part position, that is, at least two side surfaces of the first electrode 10 are coplanar. As a result, the electrode composite material droop of the end part of at least two sides of the first electrode layer 12 can be eliminated. A second collector foil 13 is bonded to a second surface of the first collector foil 11 on a side opposite to the first surface through an adhesive layer 20. The battery 100 includes one second electrode 30 including a second electrode layer 32 on a first surface of a third collector foil 31. In the second collector foil 13, the third collector foil 31 is bonded to a second surface of the second collector foil 13 on a side opposite to the first surface bonded to the first collector foil 11 through an adhesive layer 21.

FIG. 2 is a schematic view showing another example of a part of the bipolar battery according to the present disclosure. In FIG. 2, the same configurations as those in FIG. 1 are designated by the same reference numerals, and the description thereof will not be repeated.

As shown in FIG. 2, a bipolar battery 200 according to the present disclosure has at least one side of the first electrode layer end and at least one side of the first collector foil end that share the same end part position, that is, at least one side surface of the first electrode 10 is coplanar. As a result, the electrode composite material droop of the end part of at least one side of the first electrode layer 12 can be eliminated. In addition, at least one end part of a plurality of end parts of the first collector foil 11 in a surface direction toward the outside of the battery 200 includes a protruding portion 14 that extends to the outside of the battery 200 and does not face the first electrode layer 12.

FIG. 3 is a schematic view showing an example of a monopolar battery according to the present disclosure. In FIG. 3, the same configurations as those in FIG. 1 are designated by the same reference numerals, and the description thereof will not be repeated. In FIG. 3, '...' means repeating structures.

As shown in FIG. 3, a monopolar battery 300 according to the present disclosure includes a plurality of first electrodes 10 each of which includes a first electrode layer 12 on a first surface of a first collector foil 11. A second collector foil 13 is bonded to a second surface of the first collector foil 11 on a side opposite to the first surface through an adhesive layer 20. In the second collector foil 13, the first collector foil 11 is bonded to the second surface of the second collector foil 13 on a side opposite to the first surface bonded to the first collector foil 11 through the adhesive layer 20. The battery 300 includes the first electrodes 10 each of which includes the first electrode layer 12 on the first surface of the first collector foil 11 on the second surface of the second collector foil 13. As shown in FIG. 3, at least two sides of the first electrode layer end and at least two sides of the first collector foil end share the same end part position, that is, at least two side surfaces of the first electrode 10 are coplanar. As a result, the electrode composite material droop of the end part of at least two sides of the first electrode layer 12 can be eliminated. The battery 300 includes one second electrode 30 including the second electrode layer 32 on the first surface of the third collector foil 31, and includes one second electrode 30 including the second electrode layer 32 on the second surface of the third collector foil 31. A separator 50 that is an electrolyte layer is disposed between the first electrode layer 12 and the second electrode layer 32. The first electrode 10 shown in FIG. 3 is a positive electrode, and the second electrode 30 is a negative electrode.

FIG. 4 is a schematic view showing an example of a part of a bipolar battery in the related art. In FIG. 4, the same configurations as those in FIG. 1 are designated by the same reference numerals, and the description thereof will not be repeated.

As shown in FIG. 4, a bipolar battery 500 in the related art includes a plurality of first electrodes 10 each of which includes a first electrode layer 12 on a first surface of a second collector foil 13. Since the first electrode layer 12 is formed by directly coating the electrode composite material of the first electrode layer on the first surface of the second collector foil 13, an electrode composite material droop 40 is formed at the end part of the first electrode layer 12 in the surface direction. In consideration of the electrode composite material droop 40, the electrode area is reduced, and the battery capacity is reduced. In particular, in a case where the first electrode layer 12 has a two-layer structure, in a case of coating the electrode composite material of the first electrode layer 12 in two layers, it is necessary to consider not only the electrode composite material droop 40 but also a coating variation of the electrode composite material, and the electrode area is further reduced, and the battery capacity is further reduced.

The present disclosure is not limited to the embodiment. The embodiment is merely an example and anything that has substantially the same configuration as the technical idea described in the claims of the present disclosure and achieves the same effect is included in the technical scope of the present disclosure.

What is claimed is:

1. A battery comprising a plurality of first electrodes, wherein:
each of the first electrodes includes a first collector foil and a first electrode layer on a first surface of the first collector foil;
a position of at least one end part of four end parts of the first electrode layer in a surface direction is the same as a position of at least one end part of four end parts of the first collector foil in the surface direction;
at least one side surface of four side surfaces of the first electrode is coplanar; and
the first electrodes are disposed on a first surface of a single second collector foil at intervals that are predetermined.

2. The battery according to claim 1, wherein:
the first collector foil includes a resin and an inorganic filler having conductivity; and
the resin is a thermally fusible resin.

3. The battery according to claim 1, wherein:
each of the first collector foils of the first electrodes is bonded to the second collector foil through an adhesive layer;
the adhesive layer includes an adhesive and an inorganic filler having conductivity; and
the adhesive is a thermally fusible resin.

4. A manufacturing method of the battery according to claim 1, the manufacturing method comprising forming the first electrode layer on the first surface of the first collector foil by dry film formation.

5. The manufacturing method according to claim 4, further comprising:
preparing the first electrodes after the forming; and
disposing the first electrodes on the first surface of the single second collector foil at the intervals that are predetermined.
